(19) United States
(12) Patent Application Publication
(10) Pub. No.: US 2013/0143984 A1
(43) Pub. Date: Jun. 6, 2013

(54) PRODUCTION OF CURED EPOXY RESINS WITH FLAME-RETARDANT PHOSPHONATES

(71) Applicants: Michael Henningsen, Frankenthal (DE); Achim Kaffee, Lorsch (DE); Jean-Francois Stumbe, Strasbourg (FR); Manfred Doering, Woerth (DE); Alexander Schmidt, Essen (DE); Lin Zang, Karlsruhe (DE); Volker Altstaedt, Bayreuth (DE); Johannes Kraemer, Oftersheim (DE)

(72) Inventors: Michael Henningsen, Frankenthal (DE); Achim Kaffee, Lorsch (DE); Jean-Francois Stumbe, Strasbourg (FR); Manfred Doering, Woerth (DE); Alexander Schmidt, Essen (DE); Lin Zang, Karlsruhe (DE); Volker Altstaedt, Bayreuth (DE); Johannes Kraemer, Oftersheim (DE)

(73) Assignee: BASF SE, Ludwigshafen (DE)

(21) Appl. No.: 13/491,074

(22) Filed: Jun. 7, 2012

Related U.S. Application Data
(60) Provisional application No. 61/494,899, filed on Jun. 9, 2011.

(51) Int. Cl. C08K 5/5373; C08K 5/5333

(52) U.S. Cl. CPC C08K 5/5373; C08K 5/5333
USPC 523/451; 558/179; 558/85; 558/180; 558/214; 544/214

(57) ABSTRACT

The invention relates to curable compositions which comprise epoxy resins, amino hardeners, and a phosphonate of the formula I. Addition of phosphonate of the formula I can give cured epoxy resins which have not only improved flame retardants but also an increased glass transition temperature when comparison is made with the corresponding resins without said addition.

The present patent application includes by reference the U.S. provisional application No. 61/494,899 filed on Jun. 9, 2011.

The present invention relates to processes for producing cured epoxy resins with phosphonate of the formula I in a proportion of altogether up to 2.5% by weight of phosphorus, based on the entire composition which have, or which can develop as a result of thermal post treatment, an increased glass transition temperature when comparison is made with the corresponding cured epoxy resins without said phosphonate addition. The curable composition which includes an epoxy compound, a hardener comprising amino groups (amino hardener), and a phosphonate of the formula I is cured here and then optionally heat-conditioned.

The invention further relates to the curable composition which is used for the process of the invention and which comprises one or more epoxy compounds, one or more amino hardeners, and one or more phosphonates of the formula I in a proportion of altogether up to 2.5% by weight of phosphorus, based on the entire composition.

The invention likewise provides cured epoxy resin which can be produced by the process of the invention, starting from the components epoxy compound, amino hardener, and phosphonate of the formula I in a proportion of altogether up to 2.5% by weight of phosphorus, based on the entire composition, where the cured epoxy resin has, or can develop through thermal post treatment, an increased glass transition temperature when comparison is made with the corresponding cured epoxy resins without said phosphonate addition.

The invention also provides a molding produced from the epoxy resin cured in the invention.

Many polymeric materials, for example epoxy resins, are flammable and in the event of fire can generate large amounts of heat and/or toxic smoke. Addition of flame retardants can counter this disadvantage, and in numerous applications is unavoidable and/or required by legislation.

The flame retardants act to reduce the flammability of the polymers (producing self-extinguishing materials) and reduce the amount of heat generated in the event of a fire. In principle, the flame retardants act by inter alia increasing carbonization in the event of a fire, where this then reduces the amount of combustible material and forms a protective surface layer (solid-phase mechanism), and also by intumescence, i.e. formation of a voluminous insulating layer, this being brought about by additional liberation of gases (solid-phase mechanism), and also by liberating free-radical species which scavenge reactive free radicals in the gas phase and thus inhibit the combustion process (gas-phase mechanism).

Phosphorus-containing flame retardants are achieving increasing importance, being flame retardants that are not hazardous to the environment. The flame-retardant action of phosphorus-containing flame retardants has been shown to derive both from gas-phase mechanisms and from solid-phase mechanisms, and the range of applications is therefore wide. Phosphorus-containing compounds are usually applied in a proportion of approximately at least 3% by weight of phosphorus, based on the entire composition to ensure optimal flame-retardant action.

Esters of phosphonic acid (phosphonates) have already been used for more than 40 years for flame retardancy in textiles (U.S. Pat. No. 3,721,523). Halogenated phosphonates have also been patented during that period (U.S. Pat. No. 3,372,298, U.S. Pat. No. 3,349,150, U.S. Pat. No. 3,636,061, DE 2443074) for flame retardancy in epoxy resins and in polyurethanes. Phosphoramidomethylphosphonates have also been described (U.S. Pat. No. 4,053,450) as flame retardant for various polymers, such as polypropylene, polystyrene, nylon, polyethylene terephthalate, and epoxy resins. A familiar flame retardant from the phosphonates group is dimethyl methylphosphonate, which has also been described as additive for epoxy resins (J Appl Pol Sci 2002, 84:302). GB 1002326 discloses compositions comprising epoxy compounds and dialkyl phosphite compounds as flame-retardant component. EP 923587 discloses flame-retardant curable compositions containing cyclic phosphonate and an epoxy compound. DE 19613066 describes phosphorus-modified epoxy resins which have been converted with carboxy group-containing phosphine acids or phosphonate acids.

However, the addition of these phosphonates as flame retardants to epoxies in the prior art generally has an adverse effect on glass transition temperature (T_{g})-glass transition temperature is mostly reduced as a result of this type of addition or at best remains unaltered, whereas high glass transition temperature is important for producing moldings or components which retain their stability even when they are exposed to high temperatures.

U.S. Pat. No. 4,111,909 describes the addition of phosphonates to mixtures of epoxy compounds and a dicyandiamide hardener for modulating the curing time, whereas a influence of the glass transition temperature is not suggested.

Additions to epoxy resins mostly lower glass transition temperature.

Reactive additions which react with the epoxy groups of the epoxy compounds reduce the number of these and thus reduce the extent of crosslinking, and consequently reduce glass transition temperature. Additions of additives which do not react with the epoxy groups of the epoxy compounds generally have a plasticizing effect on the network. The greater this effect, the lower the resultant glass transition temperature. Additional postcrosslinking can be used to increase glass transition temperature (Davis and Rawlins, 2009 SAMPE Fall Technical Conference & Exhibition; Wichita, Kans.; Oct. 19-22, 2009). Known agents for this type of postcrosslinking are capped isocyanate derivatives, such as uretdiones or isocyanurates.

There is also a description (U.S. Pat. No. 6,201,074, U.S. Pat. No. 4,632,973) of the use, as comonomers for epoxy resins, of phosphonates functionalized with epoxy groups or with amino groups. However, despite a long time for curing and heat-conditioning, the glass transition temperatures of the epoxy resins cured in the presence of these co-monomers are usually comparatively low, usually from 100 to 135° C. Another disadvantage is the complicated synthesis of these comonomers.

It would be desirable to have the possibility of simultaneous increase of glass transition temperature in cured epoxy resins made of epoxy resin mixtures with phosphonates as flame retardants.

An object of the invention can therefore be considered to be the provision of processes for producing cured epoxy resins from epoxy resin formulations which include phosphonates and simultaneously have, or can develop, comparatively high glass transition temperatures, and also the provision of corresponding epoxy resin formulations and of corresponding cured epoxy resins.

The present invention correspondingly provides epoxy resin formulations (curable compositions) comprising one or more epoxy compounds, one or more amino hardeners having at least one primary or at least two secondary amino groups, and one or more phosphonates of the formula I

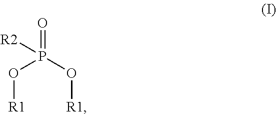

where
R1 are mutually independently alkyl or aryl groups or substituted aryl, alkaryl, or alkenyl groups, preferably alkyl groups,
and where R2 is an H atom or a propionic acid moiety of the formula —CH₂—CH₂—COOR3,
and where the proportion of phosphonate of the formula I is up to 2.5% by weight of phosphorus, based on the entire composition

Preference is given to phosphonates of the formula I in which R1 are mutually independently alkyl groups having from 1 to 5 carbon atoms, particularly, having from 1 to 3 carbon atoms and having no heteroatoms. In one variant, the two R1 groups join together to form an alkylene bridging moiety, where said moiety preferably has from 2 to 10 carbon atoms, particularly, having from 2 to 6 carbon atoms and no heteroatoms. Preference is given to phosphonates of the formula I in which R1 are mutually independently alkyl groups having from 1 to 5 carbon atoms, particularly, having from 1 to 3 carbon atoms and having no heteroatoms and in which the two R1 groups are not join together to form an alkylene bridging moiety.

Preference is further given to phosphonates of the formula I in which R2 is an H atom.

Particular preference is given to phosphonates of the formula I in which R1 are mutually independently alkyl groups having from 1 to 5 carbon atoms, particularly, having from 1 to 3 carbon atoms and having no heteroatoms, and R2 is an H atom, and also to phosphonates of the formula I in which the two R1 groups join together to form an alkylene bridging moiety having from 2 to 10 carbon atoms, particularly, having from 2 to 6 carbon atoms and having no heteroatoms, and R2 is an H atom. Examples of suitable phosphonates of the formula I are dimethyl phosphite (DMP, formula II), diethyl phosphite (DEP, formula III), and 5,5-dimethyl-[1,3,2]dioxaphosphinane 2-oxide (DDPO, formula IV).

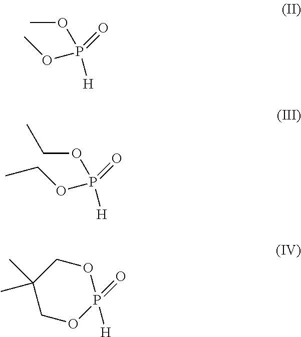

The propionic acid moiety of the formula —CH₂—CH₂—COOR3 can be present in the form of free acid (R3=H atom) or esterified with a mono- or polyhydric alcohol (R3(OH)ₙ, where n=from 1 to 4). In the case of esterification with a polyhydric alcohol, there can be covalent linking, by way of said alcohol, of a plurality of phosphonates of the formula I having a propionic acid moiety as R2.

Examples of a phosphonate compound of this type are dimethyl phosphite-methyl acrylate (DMPAc-M) with the formula V, dimethyl phosphite-acrylate-3-isocyanurate (DMPAc-3-I) with the formula VI and dimethyl phosphite-acrylate-4-pentaerythritol (DMPAc-4-P) with the formula VII

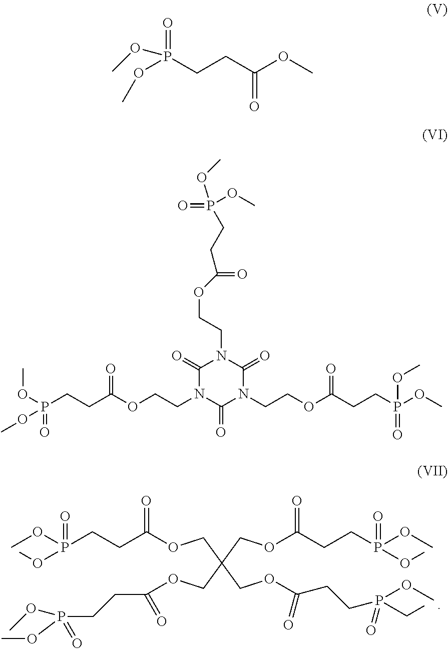

Phosphonates of the formula I having a propionic acid moiety or propionic ester moiety as R2 can be produced via Michael addition of the corresponding acrylic acid or acrylic ester with phosphonates of the formula I having an H atom as R2.

For the purposes of the invention, alkyl groups have from 1 to 20 carbon atoms, they can be linear, branched, or cyclic. It is preferable that they have no substituents having heteroatoms. Heteroatoms are all atoms other than C atoms and H atoms.

For the purposes of the invention, aryl groups have from 5 to 20 carbon atoms. It is preferable that they have no substituents having heteroatoms. Heteroatoms are all atoms other than C atoms and H atoms.

Hardener-free preformulations comprising one or more epoxy compounds and one or more phosphonates of the formula I have good shelf life. The amino hardener can then be brought into contact with, and mixed with, the preformulation prior to the curing step.

Amino hardeners suitable for the polyaddition reaction have at least two secondary amino groups or at least one primary amino group. Linking of the amino groups of the amino hardener with the epoxy groups of the epoxy compound forms oligomers from the amino hardeners and the epoxy compounds. The amounts used of the amino hardeners are therefore generally stoichiometric in relation to the epoxy compounds. If, by way of example, the amino hardener has two primary amino groups, i.e. can couple with up to four epoxy groups, crosslinked structures can result.

The amino hardeners of the curable composition of the invention have at least one primary amino group or two secondary amino groups. An amino compound having at least two amino functions can be used for curing via a polyaddition reaction (chain extension) starting from epoxy compounds having at least two epoxy groups. The functionality of an amino compound here corresponds to its number of NH bonds. A primary amino group therefore has functionality 2, whereas a secondary amino group has functionality 1. Linking of the amino groups of the amino hardener to the epoxy groups of the epoxy compound forms oligomers from the amino hardener and the epoxy compound, and the epoxy groups here are converted to free OH groups. It is preferable to use amino hardeners having a functionality at least 3 (for example at least 3 secondary amino groups or at least one primary and one secondary amino group), in particular those having two primary amino groups (functionality 4).

Preferred amino hardeners are dimethyl dicycane (DMDC), dicyandiamide (DICY), isophoronediamine (IPDA), diethylenetriamine (DETA), triethylenetetramine (TETA), bis(p-aminocyclohexyl)methane (PACM), methylenedianiline (e.g. 4,4′-methylenedianiline), polyetheramine D230, diaminodiphenylmethane (DDM), diaminodiphenyl sulfone (DDS), 2,4-toluenediamine, 2,6-toluenediamine, 2,4-diamino-1-methylcyclohexane, 2,6-diamino-1-methyl-cyclohexane, 2,4-diamino-3,5-diethyltoluene, and 2,6-diamino-3,5-diethyltoluene, and also mixtures thereof. Particularly preferred amino hardeners for the curable composition of the invention are dimethyl dicycane (DMDC), dicyandiamide (DICY), isophoronediamine (IPDA), and methylenedianiline (e.g. 4,4′-methylenedianiline).

In the curable composition of the invention it is preferable that the amounts used of epoxy compound and of amino hardener are approximately stoichiometric, based on the epoxy functionality and, respectively, the amino functionality. Particularly suitable ratios of epoxy groups to amino functionality are by way of example from 1:0.8 to 1:1.2.

The proportion of the phosphonates of the formula I, based on the curable composition of the invention (% P: atom % of phosphorus, percent by weight of phosphorus, based on the entire composition) is preferably at least 0.1% P. Below a proportion of this type, the invention provides little improvement of flame retardancy and of glass transition temperature. It is preferable that the compositions of the invention comprise at least 0.2% P, particularly at least 0.5% P. It is preferable in the invention to avoid exceeding a proportion of 2% P, preferably 1.5% P. An excessive proportion of phosphonate of the formula I can cause increased embrittlement of the cured material on crosslinking, or in the absence of crosslinking can have a plasticizing effect, and in turn reduce the glass transition temperature of the cured material.

Epoxy compounds of this invention have from 2 to 10 epoxy groups, preferably from 2 to 6, very particularly preferably from 2 to 4, and in particular 2. The epoxy groups are in particular glycidyl ether groups of the type produced during the reaction of alcohol groups with epichlorohydrin. The epoxy compounds can be low-molecular-weight compounds, which generally have an average molar mass (Mn) smaller than 1000 g/mol, or can be relatively high-molecular-weight compounds (polymers). The degree of oligomerization of these polymeric epoxy compounds is preferably from 2 to 25 units, particularly preferably from 2 to 10 units. The compounds can be aliphatic, or cycloaliphatic, or compounds having aromatic groups. In particular, the epoxy compounds are compounds having two aromatic or aliphatic 6-membered rings, or are oligomers of these. Epoxy compounds important industrially are those obtainable via reaction of epichlorohydrin with compounds which have at least two reactive H atoms, in particular with polyols. Epoxy compounds of particular importance are those obtainable via reaction of epichlorohydrin with compounds which have at least two, preferably two, hydroxy groups, and two aromatic or aliphatic 6-membered rings. Compounds of this type that may be mentioned are in particular bisphenol A and bisphenol F, and also hydrogenated bisphenol A and bisphenol F. Bisphenol A diglycidyl ether (DGEBA) is an example of an epoxy compound usually used in this invention. Other suitable epoxy compounds in this invention are tetraglycidyl-methylenedianiline (TGMDA) and triglycidylaminophenol, and mixtures thereof. It is also possible to use reaction products of epichlorohydrin with other phenols, e.g. with cresols or with phenol-aldehyde adducts, examples being phenol-formaldehyde resins, in particular novolaks. Other suitable epoxy compounds are those which do not derive from epichlorohydrin. Examples that can be used are epoxy compounds which comprise epoxy groups via reaction with glycidyl (meth)acrylate. It is preferable in the invention to use epoxy compounds or mixtures thereof which are liquid at room temperature (25° C.).

The curable compositions of the invention comprise not only compositions that are liquid at room temperature (25° C.) but also compositions that are solid at room temperature (25° C.). The compositions can include liquid or solid components in accordance with the desired use. It is also possible to use mixtures made of solid and liquid components, for example in the form of solutions or dispersions. By way of example, mixtures made of solid components are utilized for the use in the form of powder coatings. Mixtures made of liquid components are particularly important for producing fiber-reinforced composite materials. The physical condition of the epoxy resin can in particular be adjusted via the degree of oligomerization. It is preferable that the curable composition is liquid.

The curable composition of the invention can also comprise an accelerator for the curing process. Examples of suitable accelerators for the curing process are imidazole and imidazole derivatives, and urea derivatives (urons), such as 1,1-dimethyl-3-phenylurea (fenuron). There is also a description (U.S. Pat. No. 4,948,700) of the use of tertiary amines, such as triethanolamine, benzyldimethylamine, 2,4,6-tris(dimethylaminomethyl)phenol, and tetramethylguanidine as accelerators for the curing process. It is known, for example, that addition of fenuron can accelerate the curing of epoxy resins with DICY.

Examples of curable compositions of the invention are the combination comprising DGEBA, DMDC, and a phosphonate selected from the group consisting of DMP, DEP, and DDPO, the combination comprising DGEBA, DICY, and a phosphonate selected from the group consisting of DMP, DEP, and DDPO, the combination comprising DGEBA, DICY, fenuron, and a phosphonate selected from the group consisting of DMP, DEP, and DDPO, the combination comprising DGEBA, IPDA, and a phosphonate selected from the group consisting of DMP, DEP, and DDPO, and also the combination comprising RTM6 (a preformulated resin-hardener mixture), and a phosphonate selected from the group consisting of DMP, DEP, DMPAc-M, DMPAc-4-P, and DMPAc-3-I. Examples of preformulations are the amino-hardener-free combination comprising DGEBA and a phosphonate selected from the group consisting of DMP, DEP, and DDPO, the combination comprising DGEBA, fenuron, and a phosphonate selected from the group consisting of DMP, DEP, and DDPO, the combination comprising triglycidylaminophenol and a phosphonate selected from the group consisting of DMP, DEP, DMPAc-M, DMPAc-4-P, and DMPAc-3-I, and also the combination comprising tetraglycidylmethylenedianiline and a phosphonate selected from the group consisting of DMP, DEP, DMPAc-M, DMPAc-4-P, and DMPAc-3-I.

In one variant of the curable composition of the invention, this comprises no other phosphorus compounds alongside the phosphonates of the formula I of the invention, or comprises at most a proportion of 0.5% P or more specifically of 0.1% P of other phosphorus compounds.

In one variant of the curable composition of the invention, this comprises no hardeners other than the amino hardeners of the invention, or comprises at most a proportion of 1% by weight of other hardeners.

The invention further provides a process for producing cured epoxy resins from the curable composition of the invention with phosphonate addition which have, or which develop as a result of thermal post treatment, an increased glass transition temperature when comparison is made with the corresponding epoxy resins without said phosphonate addition. The cured epoxy resins obtainable in the invention have an increased glass transition temperature when comparison is made with the corresponding cured epoxy resins without the phosphonate addition, or can develop this increased glass transition temperature via thermal post treatment. It is preferable that this increase in glass transition temperature is at least 10° C., in particular at least 20° C.

In the process of the invention for producing these cured epoxy resins which have a comparatively high glass transition temperature or which can develop the same via thermal post treatment, the components (epoxy compound, amino hardener, phosphonate of the formula I, and optionally further components, such as accelerators) are brought into contact with, and mixed with, one another in any desired sequence, and then cured, and preferably exposed to thermal post treatment, for example in the context of the curing process or in the context of optional downstream heat-conditioning.

The curing process can take place at atmospheric pressure and at temperatures below 250° C., in particular at temperatures below 210° C., preferably at temperatures below 185° C., in particular in a temperature range from 40 to 210° C., more preferably in a temperature range from 40 to 185° C.

The curing process usually takes place in a mold until dimensional stability has been achieved and the workpiece can be removed from the mold. The subsequent process for reducing intrinsic stresses in the workpiece and/or for completing the crosslinking of the cured epoxy resin is termed heat-conditioning. In principle, it is also possible to carry out the heat-conditioning process prior to removal of the workpiece from the mold, for example in order to complete the crosslinking process. The heat-conditioning process usually takes place at temperatures at the limit of dimensional rigidity (Menges et. al., “Werkstoffkunde Kunststoffe” [Plastics materials] (2002), Hanser-Verlag, 5th edition, p. 136). The usual heat-conditioning temperatures are from 120 to 220° C., preferably from 150 to 220° C. The period for which the cured workpiece is exposed to the conditions of the heat-conditioning process is usually from 30 to 240 min. Longer heat-conditioning times can also be appropriate, depending on the dimensions of the workpiece.

The thermal post treatment of the cured epoxy resin of the invention is essential for developing the increased glass transition temperature. It preferably takes place at a temperature above the glass transition temperature of the corresponding cured epoxy resin without addition of phosphonate of the formula I. The temperature at which the thermal post treatment usually takes place is from 150 to 250° C., in particular from 180 to 220° C. more preferably from 190 to 220° C., and the usual thermal post treatment period is from 30 to 240 min. The ideal conditions for the thermal post treatment (temperature and time) differ from case to case, depending on the components of the epoxy system (resin, hardener, and additions), and also on the geometry of the workpiece. The glass transition temperature of the cured epoxy resin can be increased up to a maximum by increasing the post treatment time and/or increasing the post treatment temperature. If post treatment conditions exceed these levels, degradation processes can occur in the cured epoxy resin and there can be a resultant reduction of glass transition temperature. Series of tests are usually used to determine the ideal conditions for thermal post treatment for the respective epoxy system and the respective application (e.g. workpiece). It is preferable that the thermal post treatment is carried out at temperatures in the range from 20° C. below to 40° C. above, in particular in the range from 10° C. below to 20° C. above, the glass transition temperature that prevails at the start of thermal post treatment. In one preferred variant, thermal post treatment uses an increase in temperature which follows the increase of glass transition temperature. Thermal post treatment is terminated at the latest when the maximum glass transition temperature has been reached. It is preferable to carry out the thermal post treatment in such a way that the cured epoxy resin of the invention develops a glass transition temperature increased by at least 10° C., in particular by at least 20° C., when comparison is made with the corresponding cured epoxy resin without addition of the phosphonate of the formula I under otherwise identical conditions. The thermal post treatment can take place before the curing process has ended, i.e. by way of example in the shaping mold, if the curing conditions (temperature and time) are adequate for developing the increased glass transition temperature of the invention. It is preferable that the thermal post treatment takes the form of heat-conditioning downstream of the curing process, generally outside the shaping mold. If the thermal post treatment takes place in the context of heat-conditioning outside the shaping mold, it is then preferable to select post treatment conditions under which the dimensional rigidity of the workpiece is retained. Although thermal post treatment can also be used for epoxy systems without the inventive addition of phosphonate to increase the glass transition temperature to a moderate extent via postcrosslinking (until complete crosslinking has occurred), the increase of glass transition temperature is significantly more pronounced in the case of the systems of the invention with addition of phosphonate of the formula I.

As an alternative, it is possible to omit thermal post treatment during production of the cured epoxy resin. Although the cured epoxy resin does not then initially have an increased glass transition temperature it has potential for increasing glass transition temperature. In the event of a slow temperature rise extending above the initial glass transition temperature, the glass transition temperature then rises concomitantly. The cured epoxy resin therefore has dynamic potential to increase stability. In this instance, the thermal post treatment can if necessary take place when the cured epoxy resin or, respectively, the corresponding molding is in use or, respectively, subjected to thermal stress.

In one embodiment of the process of the invention for producing these cured epoxy resins, a hardener-free preformulation made of epoxy compound and phosphonate of the formula I is first produced. This preformulation then has good shelf life. Prior to the curing step, the amino hardener is then brought into contact with, and mixed with, the preformulation.

Glass transition temperature (T_{g}) can be determined by means of dynamic mechanical analysis (DMA), for example to the standard DIN EN ISO 6721, or by using a differential calorimeter (DSC), for example to the standard DIN 53765. In the case of DMA, a rectangular test specimen is subjected to torsion, using a defined frequency and a prescribed extent of deformation. The temperature here is raised at a defined rate of increase, and storage modulus and loss modulus are recorded at fixed intervals. The former describes the stiffness of a viscoelastic material. The latter is proportional to the energy dissipated within the material. The phase shift between dynamic stress and dynamic deformation is characterized via the phase angle δ. Various methods can be used to determine glass transition temperature: maximum of the tan δ curve, maximum of the loss modulus, or a tangent method based on the storage modulus. When glass transition temperature is determined by using a differential calorimeter, a very small amount of specimen (about 10 mg) is heated in an aluminum crucible at 10 K/min, and heat flux is measured in relation to a reference crucible. This cycle is repeated three times. The glass transition is determined in the form of average value from the second and third measurement process. T_{g} can be determined from the heat-flux curve by way of the inflection point, or by using the half-width method, or by using the midpoint-temperature method.

The invention further provides the cured epoxy resin made of the composition of the invention. In particular, the invention provides cured epoxy resin which is obtainable via the process of the invention. The resultant cured epoxy resin features improved flame retardancy and increased glass transition temperature (preferably a glass transition temperature increased by at least 10° C., in particular by at least 20° C.) when comparison is made with the corresponding epoxy resin without phosphonate addition or, respectively, in the case of production without thermal post treatment, corresponding potential for increased glass transition temperature on exposure to thermal stress within said temperature range.

This type of cured epoxy resin simultaneously also has, after thermal post treatment, a higher degree of crosslinking than the corresponding cured epoxy resin without the phosphonate addition.

The degree of crosslinking of (epoxy) resins can be determined by way of example by means of Fourier-transform infrared spectroscopy (FTIR), by measuring the decrease in the signal for the chemical groups which are consumed by reaction during the crosslinking process.

The curable compositions of the invention are suitable as coating material or as impregnation material, as adhesive, for production of moldings and of composite materials, or as casting compositions for embedding, or binding or reinforcement of moldings. Examples that may be mentioned of coating materials are lacquers. In particular, the curable compositions of the invention can be used to obtain scratch-resistant protective lacquers on any desired substrates, e.g. made of metal, of plastic, or of timber materials. The curable compositions are suitable as insulation coatings in electronic applications, e.g. as insulation coating for wires and cables. The use for producing photoresists may also be mentioned. They are in particular also suitable as repair lacquer, for example in uses including the renovation of pipes without dismantling of the pipes (cure in place pipe (CIPP) rehabilitation). They are also suitable for the sealing of floor coverings.

Composite materials (composites) comprise various materials, e.g. plastics and reinforcement materials (e.g. glass fibers or carbon fibers) bonded to one another.

A production process that may be mentioned for composite materials is the curing of preimpregnated fibers or fiber textiles (e.g. prepregs) after storage, or else the extrusion, pultrusion, winding, and infusion or injection processes such as vacuum infusion (VARTM), transfer molding (resin transfer molding, RTM), and also wet compression processes, such as BMC (bulk mold compression).

The curable compositions are suitable by way of example for the production of preimpregnated fibers, e.g. prepregs, and further processing of these to give composite materials. In particular, the composition of the invention can be used to saturate the fibers, which can then be cured at a relatively high temperature. No, or only slight, curing occurs during the saturation process and any optional subsequent storage.

The invention therefore further provides moldings made of the cured epoxy resin of the invention, and provides composite materials which comprise the cured epoxy resin of the invention, and also provides fibers impregnated with the curable composition of the invention.

The invention also provides the use of the phosphonates of the formula I of the invention as addition to mixtures made of epoxy compounds and of amino hardeners in order to increase the glass transition temperature for the resultant cured epoxy resin.

The non-limiting examples below will now be used for further explanation of the invention.

### INVENTIVE EXAMPLE 1 AND COMPARATIVE EXAMPLE 1

Cured epoxy resin made of DGEBA (Leuna Harze GmbH) and dimethyldicycan (DMDC, BASF SE) with DMP (Aldrich) (example 1) was produced as follows: 209 g of DGEBA, 21.3 g of DMP, and 69.7 g of DMDC were mixed at room temperature (phosphorus content based on the entire mixture being 2% P). Comparative example 1 used a corresponding formulation without DMP. The formulations were cured for 20 min at 90° C., 30 min at 150° C., and finally 60 min at 200° C. The specimens were then heat-conditioned at 215° C. for 100 min.

### INVENTIVE EXAMPLES 2 AND 3 AND COMPARATIVE EXAMPLE 2

Cured epoxy resin made of DGEBA, DICY (Alzchem Trostberg GmbH), and fenuron (Aldrich) with DMP (example 2) was produced as follows: 258 g of DGEBA and 21.3 g of DMP were mixed for 20 min at 60° C., and then 15.5 g of DICY and 5.2 g of fenuron were added, and the mixture was mixed at 60° C. for 5 more minutes (phosphorus content being 2% P). Comparative example 2 used a corresponding formulation but without DMP. Cured epoxy resin made of DGEBA, DICY, and fenuron with DMPAc-3-I (example 3) was produced correspondingly, but with use of 184.6 g of DGEBA, 11 g of DICY, 3.7 g of fenuron, and 50.7 g of DMPAc-3-I (phosphorus content being 2.5%). For the curing process, the formulations were heated from 90° C. at 2° C. per min to 110° C. and then for 1 h at 130° C. and 2 h at 160° C., and then heat-conditioned at 200° C. for 1 h.

### INVENTIVE EXAMPLE 3A

DMPAc-3-I was produced from triethylacrylathoisocyanurate and dimethyl phosphite. 250.0 g (0.59 mol) of triethylacrylathoisocyanurate (TEAI), 259.9 g (2.362 mol, 4 equivalents) of dimethyl phosphite (DMP), and also 2.2 g (0.016 mol) of 1,5,7-triazabicyclo[4.4.0]dec-5-ene (TBD) were heated to 50° C. in a 1000 ml round-bottomed flask with reflux condenser, argon inlet, and magnetic stirrer. A further 2.0 g of TBD were added three times at intervals of 2 h, and the reaction mixture was stirred at 50° C. overnight. The product is then dried under high vacuum at 80° C. for 8 h.

### INVENTIVE EXAMPLES 4 TO 6 AND COMPARATIVE EXAMPLE 3

RTM6 with DMPAc-M (example 4), or with DMPAc-4-P (example 5), or with DMPAc-3-I (example 6) was produced as follows: 100 g of RTM6 (Hexcel) and 6.76 g of DMPAc-M, or, respectively, 6.84 g of DMPAc-4-P, or, respectively, 8.83 g of DMPAc-3-I were mixed at 60° C. (phosphorus content being in each case 1% P). Comparative example 3 used 100 g of RTM6 without addition of phosphonate. For the curing process, the formulations were heated from room temperature to 180° C. at 4° C. per min, with stops at 100° C. (10 min), at 120° C. (10 min), and at 180° C. (150 min). The specimens were then heat-conditioned at 215° C. for 100 min.

### INVENTIVE EXAMPLE 4A

DMPAc-M was produced from methyl acrylate and dimethyl phosphite. 20.0 g (0.23 mol, 21.0 ml) of methyl acrylate, 25.6 g (0.23 mol, 21.3 ml) of dimethyl phosphite (DMP), and also 650 mg (4.6 mmol, 0.02 equivalents) of 1,5,7-triazabicyclo[4.4.0]dec-5-ene (TBD) were heated to 50° C. for 3 days in a 100 ml round-bottomed flask with reflux condenser, argon inlet, and magnetic stirrer. The crude product was isolated via vacuum distillation at from 10 to 3 mbar and 82° C. with a yield of 34.8 g (76%) in the form of colorless, low-viscosity liquid.

### INVENTIVE EXAMPLE 5A

DMPAc-4-P was produced from pentaerythritol tetraacrylate and dimethyl phosphite. 20.0 g (0.057 mol) of pentaerythritol tetraacrylate (PETA), 31.23 g (0.284 mol, 5 equivalents) of dimethyl phosphite (DMP), and also 0.39 g (2.9 mmol) of 1,5,7-triazabicyclo[4.4.0]dec-5-ene (TBD) were heated to 50° C. in a 250 ml round-bottomed flask with reflux condenser, argon inlet, and magnetic stirrer. A further 0.39 g of TBD was added three times at intervals of 2 h, and the reaction mixture was stirred at 50° C. overnight. The product was then dried under high vacuum at 80° C. for 8 h.

### INVENTIVE EXAMPLE 7

Cured epoxy resin made of DGEBA, DMDC, and DMP was produced as described in inventive example 1, but with use of 205 g of DGEBA, 68.3 g of DMDC, and 26.6 g of DMP (phosphorus content being 2.5% P).

### INVENTIVE EXAMPLES 8 AND 9 AND COMPARATIVE EXAMPLE 4

Cured epoxy resin made of DGEBA and DMDC with DEP instead of DMP was produced as described in inventive example 1, and with use of 204.9 g of DGEBA, 26.8 g of DEP, and 68.3 g of DMDC (phosphorus content being 2.0% P, inventive example 8), or with use of 204.9 g of DGEBA, 6.7 g of DEP, and 68.3 g of DMDC (phosphorus content being 0.5% P, inventive example 9), or with use of 204.9 g of DGEBA, 40.1 g of DEP, and 68.3 g of DMDC (phosphorus content being 3.0% P, comparative example 4).

### INVENTIVE EXAMPLE 10

Cured epoxy resin made of DGEBA and DMDC with DMPAc-4-P instead of DMP was produced as described in inventive example 1, but with use of 204.9 g of DGEBA, 68.3 g of DMDC, and 40.1 g of DMPAc-4-P (phosphorus content being 2.0%).

### COMPARATIVE EXAMPLE 5

Cured epoxy resin made of DGEBA, DMDC, and dimethyl methylphosphonate (DMMP; Aldrich) was produced as described in inventive example 1, but with use of 207 g of DGEBA, 69 g of DMDC, and 24 g of DMMP (phosphorus content being 2.0%).

### COMPARATIVE EXAMPLES 6 AND 7

Cured epoxy resin made of DGEBA and methylhexylhydrophthalic anhydride (MHHPSA, an anhydride hardener having no amino groups; Duroplast-Chemie) with DMP (comparative example 6) was produced as follows: 182 g of DGEBA, 27 g of DMP, and 168 g of MHHPSA were mixed for 20 min at room temperature. 3.5 g of 1-ethyl-3-methylimidazolium diethyl phosphate (BASF SE) were then added as catalyst, and the mixture was mixed for 5 more minutes (phosphorus content being 2.0% P). The same composition was produced analogously but with no DMP (comparative example 7). The formulation was cured at 100° C. for 3 h. The specimens were then heat-conditioned at 200° C. for 1 h.

### INVENTIVE EXAMPLES 11 TO 14 AND COMPARATIVE EXAMPLES 8 AND 9

Inventive examples 11 to 14 and comparative examples 8 and 9 correspond to inventive examples 1, 3, 7, 9, and comparative examples 4 and 1 (in this sequence), but without the heat-conditioning step.

### INVENTIVE EXAMPLE 15

Glass transition temperature T_{g} of the resin specimens from inventive examples 1 to 14 and from comparative examples 1 to 9 was determined by using dynamic mechanical analysis (DMA) (ARES RDA III, Rheometrics Scientific). For this, a rectangular test specimen was subjected to torsion, using a defined frequency and a prescribed extent of deformation (DIN EN ISO 6721). The temperature here is raised at a defined rate of increase, and storage modulus and loss modulus are recorded at fixed intervals. The former describes the stiffness of a viscoelastic material. The latter is proportional to the energy dissipated within the material. The phase shift between dynamic stress and dynamic deformation is characterized via the phase angle δ. Glass transition temperature T_{g} was determined as maximum of the tan δ curve. Tables 1 and 2 collate the results.

TABLE 1
Inventive examples and comparative examples
with heat-conditioning of the cured resin

| | Resin | Hardener | Phosphonate | T_{g} (° C.) |
|---|---|---|---|---|
| Ex. 1 | DGEBA | DMDC | DMP (2% P) | 204 |
| Comp. ex. 1 | DGEBA | DMDC | | 186 |
| Ex. 2 | DGEBA | DICY | DMP (2% P) | 154 |
| Ex. 3 | DGEBA | DICY | DMPAc-3-I (2.5% P) | 149 |
| Comp. ex. 2 | DGEBA | DICY | | 139 |
| Ex. 4 | RTM6 | | DMPAc-M (1% P) | 258 |
| Ex. 5 | RTM6 | | DMPAc-4-P (1% P) | 256 |
| Ex. 6 | RTM6 | | DMPAc-3-I (1% P) | 259 |
| Comp. ex. 3 | RTM6 | | | 226 |
| Ex. 7 | DGEBA | DMDC | DMP (2.5% P) | 192 |
| Ex. 8 | DGEBA | DMDC | DEP (2% P) | 206 |
| Ex. 9 | DGEBA | DMDC | DEP (0.5% P) | 208 |
| Comp. ex. 4 | DGEBA | DMDC | DEP (3% P) | 185 |
| Ex. 10 | DGEBA | DMDC | DMPAc-4-P (2% P) | 193 |
| Comp. ex. 5 | DGEBA | DMDC | DMMP (2% P) | 189 |
| Comp. ex. 6 | DGEBA | MHHPSA | DMP (2% P) | 141 |
| Comp. ex. 7 | DGEBA | MHHPSA | | 163 |

TABLE 2
Comparative examples without heat-conditioning of the cured resin

| | Resin | Hardener | Phosphonate | Tg (° C.) |
|---|---|---|---|---|
| Ex. 11 | DGEBA | DMDC | DMP (2% P) | 174 |
| Ex. 12 | DGEBA | DICY | DMPAc-3-I (2.5% P) | 133 |
| Ex. 13 | DGEBA | DMDC | DMP (2.5% P) | 163 |
| Ex. 14 | DGEBA | DMDC | DEP (0.5% P) | 168 |
| Comp. ex. 8 | DGEBA | DMDC | DEP (3% P) | 152 |
| Comp. ex. 9 | DGEBA | DMDC | | 171 |

### INVENTIVE EXAMPLE 15

The flame-retardant effect of the phosphonate-containing resin specimens of inventive examples 1 and 7 and comparative example 1, and also of inventive examples 4 to 6 and comparative example 3, was studied in accordance with the UL-94 test specification of Underwriters Laboratories (harmonized with the test specifications of IEC 60707, 60695-11-10 and 60695-11-20 and ISO 9772 and 9773) for vertical burning. The resin specimens were allocated to the UL 94 combustibility classes V-0, V-1, and V-2 in accordance with their combustion performance, where V-0 represents the best flame-retardancy class. Table 3 collates the results. n.r. means that none of said combustibility classes was appropriate, i.e. that flame retardancy is relatively poor.

TABLE 3
UL 94 combustibility classes

| | Resin | Hardener | Phosphonate | UL 94 |
|---|---|---|---|---|
| Ex. 1 | DGEBA | DMDC | DMP (2% P) | V-1 |
| Ex. 7 | DGEBA | DMDC | DMP (2.5% P) | V-0 |
| Comp. ex. 1 | DGEBA | DMDC | | n.r. |

| | | | |
|---|---|---|---|
| Ex. 4 | RTM6 | DMPAc-M (1% P) | V-0 |
| Ex. 5 | RTM6 | DMPAc-4-P (1% P) | V-0 |
| Ex. 6 | RTM6 | DMPAc-3-I (1% P) | V-0 |
| Comp. ex. 3 | RTM6 | | n.r. |

### INVENTIVE EXAMPLE 16

The shelf life of the preformulation made of DGEBA and DEP (273 g of DGEBA and 36 g of DEP, mixed in a DAC 150 FVZ Speedmixer™ from Hausschild & Co. KG) was studied at room temperature. Even after 150 days, there had been no alteration of the clear liquid mixture. An NMR study of the mixture, directly after the mixing process and after 150 days, also revealed no measurable difference.

1. A curable composition comprising one or more epoxy compounds having from 2 to 10 epoxy groups, one or more amino hardeners having at least one primary or at least two secondary amino groups, and one or more phosphonates of the formula I 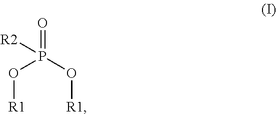
where
R1 are mutually independently alkyl or aryl groups or substituted aryl, alkaryl, or alkenyl groups, and
R2 is an H atom or a propionic acid moiety of the formula —CH₂—CH₂—COOR3, and
where the propionic acid moiety of the formula —CH₂—CH₂—COOR3 is present in the form of free acid having an H atom as R3 or is esterified with a mono- to tetrahydric alcohol R3(OH)ₙ, where n=from 1 to 4, and
where the proportion of phosphonate of the formula I is up to 2.5% by weight of phosphorus, based on the entire composition.

2. The curable composition according to claim 1, where the moieties R1 of the formula I are mutually independently alkyl groups having from 1 to 5 carbon atoms and having no heteroatoms, or join together to form an alkylene bridging moiety having from 2 to 10 carbon atoms and having no heteroatoms.

3. The curable composition according to claim 1, where the moieties R1 of the formula I are mutually independently alkyl groups having from 1 to 3 carbon atoms and having no heteroatoms, or join together to form an alkylene bridging moiety having from 2 to 6 carbon atoms and having no heteroatoms.

4. The curable composition according to claim 1, where the moieties R1 of the formula I are mutually independently alkyl groups having from 1 to 3 carbon atoms and having no heteroatoms.

5. The curable composition according to any of claims 1 to 4, where the moiety R2 of the formula I is an H atom.

6. The curable composition according to any of claims 1 to 4, where the moiety R2 of the formula I is a propionic acid moiety of the formula —CH₂—CH₂—COOR3 which has been esterified with a mono- to tetrahydric alcohol R3(OH)ₙ, where n=from 1 to 4.

7. The curable composition according to any of claims 1 to 6, where the proportion of phosphonate of the formula I is at least 0.1% by weight of phosphorus, based on the entire composition.

8. A process for producing cured epoxy resin, which comprises curing the curable composition according to any of claims 1 to 7.

9. The process for producing cured epoxy resin according to claim 8, where the curing takes place at a temperature of from 40 to 210° C.

10. The process for producing cured epoxy resin according to claim 8 or 9, where the curable composition is exposed to a thermal post treatment during or subsequently to the curing.

11. The process for producing cured epoxy resin according to claim 10, where the thermal post treatment takes place at a temperature of from 150 to 250° C.

12. A cured epoxy resin that can be produced via curing of the curable composition according to any of claims 1 to 7.

13. A molding made of the cured epoxy resin according to claim 12.

14. The use of phosphonate of the formula I, as defined in any claims 1 to 6, as addition to mixtures made of epoxy compounds and of amino hardeners in order to increase the glass transition temperature for the resultant cured epoxy resin.
